(19) United States
(12) Patent Application Publication
(10) Pub. No.: US 2013/0173991 A1
(43) Pub. Date: Jul. 4, 2013

(54) Facilitating Error Detection And Recovery In A Memory System

(71) Applicants: Frederick A. Ware, Los Altos Hills, CA (US); Brian S. Leibowitz, San Francisco, CA (US)

(72) Inventors: Frederick A. Ware, Los Altos Hills, CA (US); Brian S. Leibowitz, San Francisco, CA (US)

(21) Appl. No.: 13/820,963

(22) PCT Filed: Oct. 6, 2011
(86) PCT No.: PCT/US11/55068

§ 371 Date: Mar. 5, 2013

Related U.S. Application Data
(60) Provisional application No. 61/392,397, filed on Oct. 12, 2010.

(51) Int. Cl. G06F 11/10

(52) U.S. Cl. CPC G06F 11/10
USPC 714/763

(57) ABSTRACT

The disclosed embodiments relate to a system for accessing a data word in a memory. During operation, the system receives a request to access a data word, wherein the request includes a physical address for the data word. Next, the system translates the physical address into a mapped address, wherein the translation process spreads out the data words and intersperses groups of consecutive error information between groups of consecutive data words. Finally, the system uses the mapped address to access the data word and corresponding error information for the data word from the memory.

### TECHNICAL FIELD

The disclosed embodiments generally relate to the design of memory and controller devices for computer and other systems. More specifically, the disclosed embodiments relate to components and systems that include error detection and correction functionality.

### BACKGROUND

Error detection and correction (EDC) techniques are used in systems to detect and correct errors that arise during memory operations. These techniques typically operate by storing a data word along with an associated EDC syndrome. However, a challenge may arise when implementing EDC in, for example, mobile platforms, such as smartphones or tablet computers, which may require a relatively fewer number of memory devices.

The methods and apparatuses described herein are not limited to systems having a small number of memory components, and may be applied to systems having many memory components.

### BRIEF DESCRIPTION OF THE FIGURES

FIG. 1 presents a block diagram illustrating an embodiment of a memory system that includes a controller coupled to a multi-bank memory device through a signaling interface.

FIG. 2 illustrates an exemplary memory system which provides EDC during a read memory access.

FIG. 3 illustrates an exemplary memory system which provides EDC during a read memory access.

FIG. 4 illustrates an exemplary partition of a 1 KB row in a memory bank having 64 blocks.

FIG. 5A illustrates an exemplary address mapping logic used to convert a physical address to a mapped address which is used by the memory device.

FIG. 5B illustrates an exemplary divide-by-seven circuit.

FIG. 6 illustrates the timing for the internal signals and interface links during read memory accesses within the exemplary memory system 200.

FIG. 7 illustrates an exemplary memory system which provides EDC during a write memory access.

FIG. 8 illustrates the timing for the internal signals and interface links during the write memory accesses within the exemplary memory system 700.

FIGS. 9A and 9B illustrate block diagrams of different embodiments of a memory device.

FIGS. 10A and 10B illustrate block diagrams of different embodiments of a memory device.

FIG. 11A illustrates a system wherein an EDC generate/check block is placed on the memory controller.

FIG. 11B illustrates a system wherein an EDC generate/check block is placed on the memory device.

FIG. 12 illustrates an EDC technique which can be used to create two contiguous regions within a physical memory: one with EDC detection/correction and the other one without.

FIG. 13 illustrates elements of an exemplary memory core for a dynamic random access memory (DRAM) component.

FIG. 14 illustrates an exemplary DRAM memory device having the mat elements described in FIG. 13.

FIG. 15 illustrates a memory core of a memory bank configured such that data and EDC information can reside in the same row within the memory bank.

FIG. 16 illustrates a memory bank configured such that the data and EDC information reside in the same row within the memory bank.

### DETAILED DESCRIPTION

The disclosed embodiments relate to components of a memory system that support error detection and correction. In specific embodiments, this memory system contains a memory device (or multiple devices) which includes multiple independently accessible memory array segments, including a first segment (e.g., first memory array) and a second segment (e.g., second memory array). Moreover, the memory system is configured to store data words along with associated error-detection-and-correction (EDC) syndromes for the data words such that: (1) an EDC syndrome for a first data word located in the first segment is stored in the second segment, and (2) an EDC syndrome for a second data word located in the second segment is stored in the first segment. In some embodiments, a memory controller of the memory system is configured to access the first data word from the first segment in parallel with accessing the EDC syndrome for the first data word from the second segment. The term “error-detection-and-correction (EDC)” and the term “error information” as used in this disclosure and the appended claims generally relate to a collection of techniques that make use of redundant data representations to facilitate error-correction and/or error-detection. For example, the terms “EDC” and “error information” can apply to error-detecting codes, error-correcting codes, and codes that facilitate both error correction and error detection.

In some embodiments, the memory system is also configured to store unprotected data words without EDC syndromes, wherein the memory system does not provide EDC for the unprotected data words. More specifically, the memory system includes both an “EDC region” that supports EDC and “a non-EDC region” that does not support EDC. These EDC and non-EDC regions can exist within a single memory component, within a single bank group of a component, or within a single bank of a component. Moreover, these EDC and non-EDC regions can exist on separate memory components, or on separate bank groups within a single memory component. In an embodiment, this technique may be functional without having to otherwise design a system that uses a higher capacity memory component (i.e., with reference to a system without EDC), and the technique does not change the minimum column access or row access granularity.

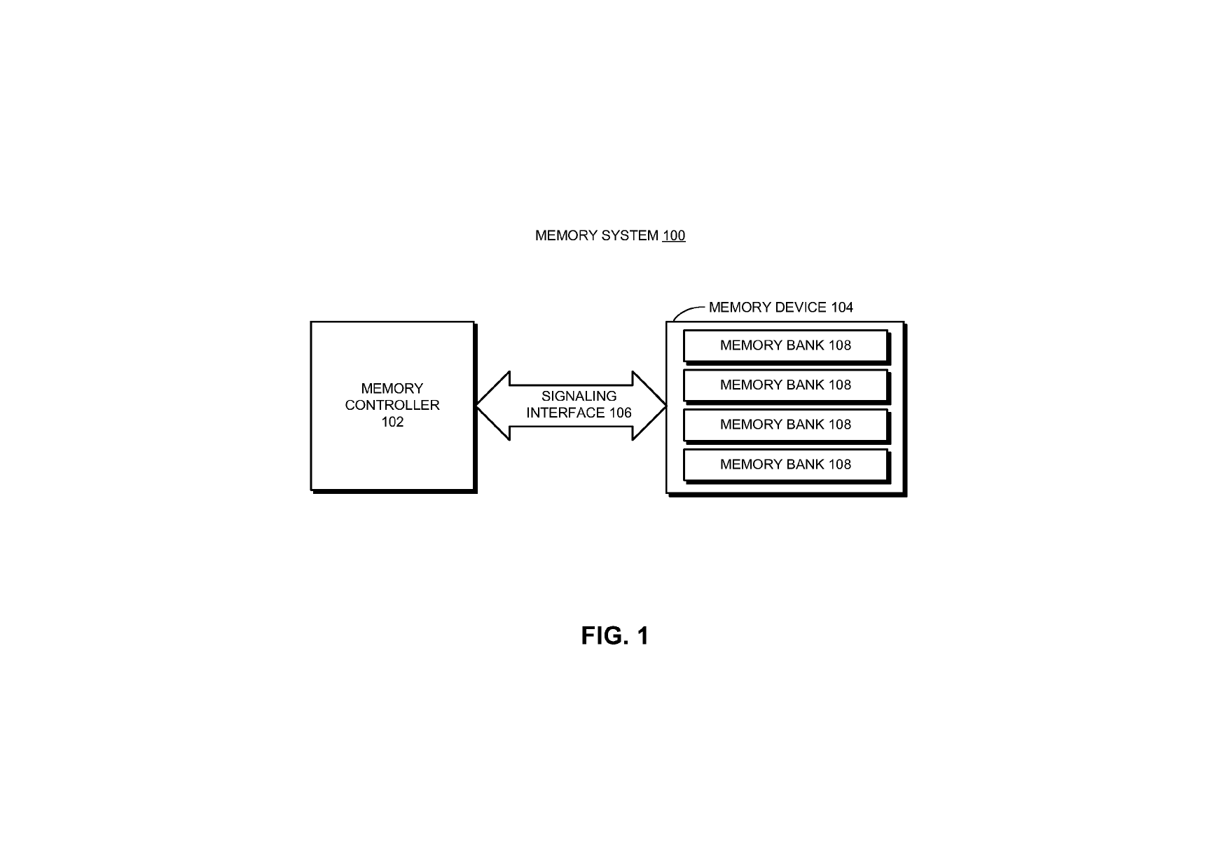

In an embodiment, a memory system includes a memory controller integrated circuit (“IC”) chip (“memory controller” or “controller” hereafter) coupled to one or more memory IC chips (“memory components” or “memory devices” hereafter) through a signaling interface. For example, FIG. 1 presents a block diagram illustrating an embodiment of a typical memory system 100, which includes a controller 102 coupled to a multi-bank memory device 104 through a signaling interface 106. While FIG. 1 illustrates memory system 100 having one memory controller and four memory banks 108, other embodiments may have additional controllers and/or fewer or more memory banks 108. In some embodiments, memory banks 108 may be organized into two or more bank groups. Each of these bank groups can include one or more memory banks 108, and the memory banks in the same bank group typically share common data (DQ) signal lines and control/command/address (CA) signal lines that are coupled to an external signaling interface. In one embodiment, memory controller 102 and memory device 104 may be integrated on the same integrated circuit (IC) die. In other embodiments, they are implemented on different integrated circuits.

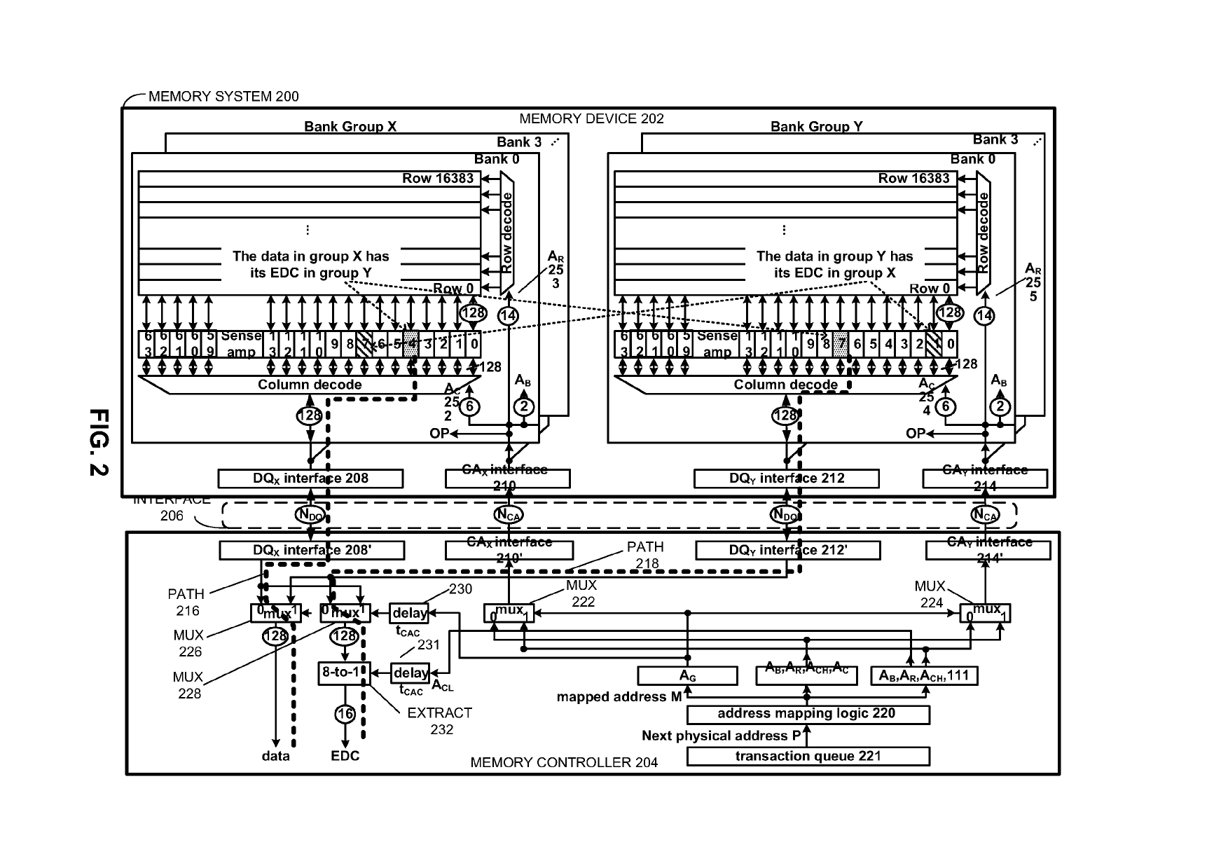

FIG. 2 illustrates an exemplary memory system 200 which provides EDC during read memory access. More specifically, memory system 200 comprises a memory device 202, which further includes two memory bank groups: bank group X and bank group Y. Note that each bank group X or Y has dedicated DQ and CA interfaces. In some embodiments, these interfaces facilitate a stream of interleaved (or overlapped) memory accesses to the associated bank group. Memory system 200 also comprises a memory controller 204 which is coupled to memory device 202 through an interface 206. As illustrated in FIG. 2, interface 206 includes N_{DQ} data (DQ) signal links and N_{CA} command (CA) signal links. More specifically, each bank group in memory device 202 couples to 128 DQ (column data) signals and 32 CA signals. These signals are then serialized to the respective DQ links and CA links in interface 206 by interface blocks 208 and 210 for bank group X and interface blocks 212 and 214 for bank group Y. Next, DQ links and CA links couple data and EDC signals to interface blocks 208′, 210′, 212′, and 214′ on the edge of memory controller 204, wherein interface blocks 208′ and 210′ deserialize the signals back to 128 DQ signals and 32 CA signals for each of the bank groups.

As illustrated in FIG. 2, each of the interface blocks in memory device 202 and memory controller 204 is denoted as either “X” or “Y” to match the designations of the two bank groups in memory device 202. (These bank groups comprise “independently accessible” memory segments.) The example illustrated in FIG. 2 illustrates four memory banks in each of two bank groups in memory device 202. However, other embodiments can have different numbers of memory banks in the bank groups. Moreover, some embodiments can include more than two bank groups.

In some embodiments, data which is stored in one bank group, for example group X, is associated with EDC information which is stored in the other bank group, i.e., group Y. During a memory access, data is accessed in one bank group, and at substantially the same time, the associated EDC information for the data is being accessed from the other bank group. In the exemplary memory device 202, each memory bank in a given bank group contains 16K rows, wherein each row contains 64 blocks of column data, and each column block contains 128 bits (128 b). As is illustrated in FIG. 2, the 128 b data column block at column address “4” in bank group X is accessed through an access path 216 (thick dotted line on the left), which includes interface blocks 208 and 208′. At the same time, the 128 b EDC column block at column address “7” in bank group Y is accessed through an access path 218 (thick dotted line on the right), which includes interface blocks 212 and 212′. This column block in group Y contains the EDC information for column blocks “0” through “6” in group X, including column block “4” which is being accessed. In one embodiment, the 4th 16 b sub-block in the 128 b EDC column block “7” in bank group Y contains the EDC information for column block “4” in bank group X. Hence, both the data from address “4” in bank group X and the associated EDC information from address “7” in bank group Y are fetched and transmitted from memory device 202 to memory controller 204 simultaneously following their respective access paths.

In a similar manner, the column blocks used for storing data in bank group Y use bank group X to store the associated EDC information for the data in bank group Y. Consequently, every time a column block is accessed in bank group Y to fetch data, a corresponding column block is accessed in bank group X to fetch the EDC sub-block associated with the data from bank group Y. For example, in memory device 202, the data column block at address “1” in bank group Y uses the second 16 b sub-block in the EDC column block at address “7” in bank group X. While FIG. 2 illustrates each column block (in either bank group X or bank group Y) as 128 b long, other embodiments can have column blocks in each memory bank containing 64 bits or other sizes.

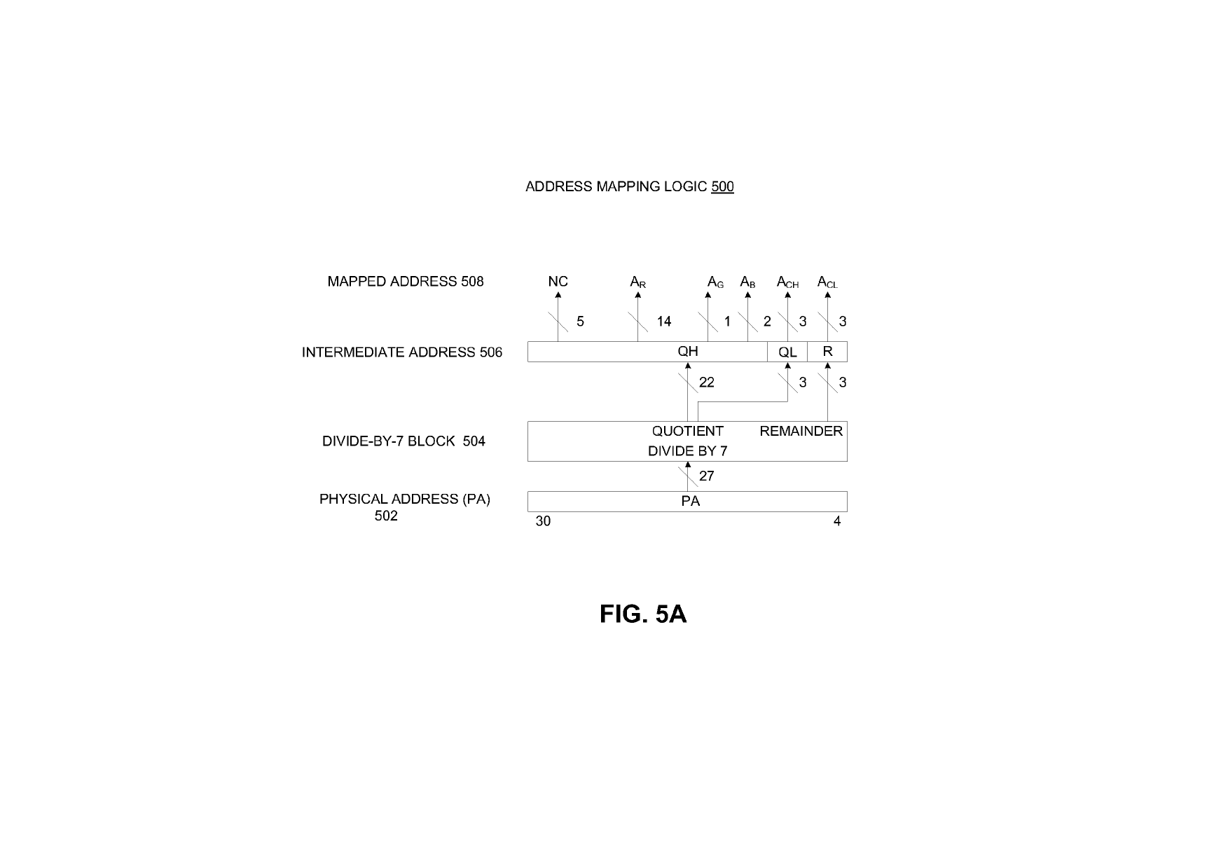

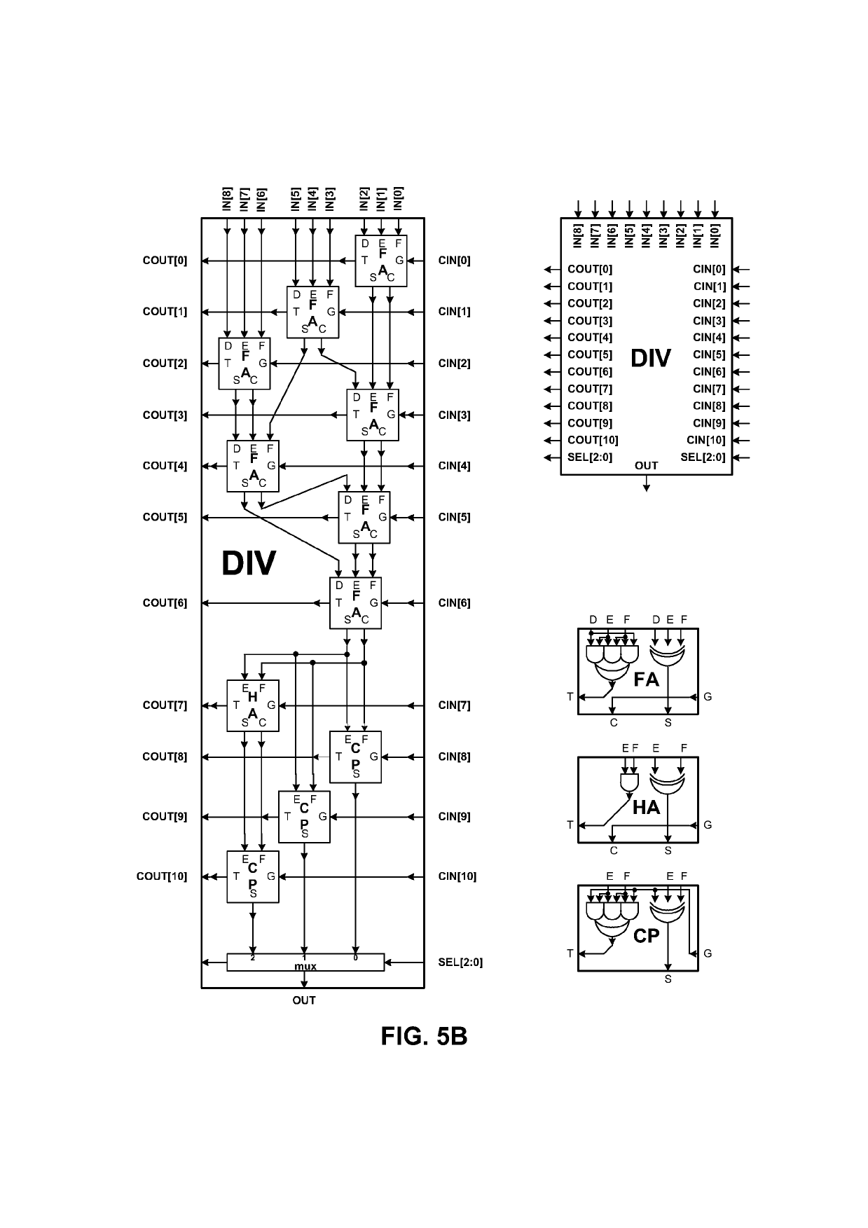

In some embodiments, to ensure that the two bank groups are accessed in lockstep during memory accesses, the memory controller provides similar column addresses for the data access and the associated EDC access at the associated CA interfaces. In memory controller 204 of memory system 200, this is implemented through address mapping logic 220, which simultaneously creates two addresses for the two correlated accesses on the two bank groups. More specifically, address mapping logic 220 receives physical addresses PA from transaction queue 221, which has previously received these physical addresses from the processor. Each physical address then passes through address mapping logic 220, which extracts different address fields from the physical address, and creates two mapped addresses based on these address fields. In some embodiments, the two mapped addresses have the same bank-address-field A_{B}, the same row-address-field A_{R}, and the same high column-address-field A_{CH}. However, the low column-address-field A_{CL} is different for the X and Y bank groups in this example. More details on generating these addresses are provided below in conjunction with FIG. 5A.

With further reference to FIG. 2, the generated addresses M from address mapping logic 220 are routed through a pair of multiplexers 222 and 224 using the associated bank-group-address-field A_{G}. Next, the addresses from the outputs of multiplexers 222 and 224 travel from memory controller 204 through interface 206 to memory device 202. Within memory device 202, these addresses feed into respective CA_{X} and CA_{Y} interfaces associated with the two bank groups X and Y. In a similar manner, during a read operation, the data column block and corresponding EDC column block fetched from the two bank groups in memory device 202 are routed from respective DQ_{X} and DQ_{Y} interfaces 208 and 212 in memory device 202 through interface 206 to memory controller 204. Within memory controller 204, the data column block and corresponding EDC column block are routed to associated data paths by a pair of multiplexers 226 and 228 based on the delayed bank-group-address-field A_{G}. This delay is achieved by using a delay element 230 which generates a delay value of “t_{CAC}” for a read access. This delay value t_{CAC} is calibrated to account for a roundtrip delay time, which is measured from when an address for a read operation is sent to memory device 202 and when the associated read data is returned to memory controller 204. During a write access, a similar operation occurs on memory system 200 with the exception that the data is transported in the opposite direction, from memory controller 204 to memory device 202.

Note that in FIG. 2 the 128 b EDC column block fetched from address “7” in bank group Y is passed through an 8-to-1 extracting circuit 232, which extracts a 16-bit subfield from a larger 128-bit file. More specifically, it selects the 16 b EDC subblock corresponding to the fetched read data from address “4” in bank group X or from address “1” in bank group Y. In this embodiment, extracting circuit 232 is controlled by the delayed low column-address-field A_{CL}, with a delay value of “t_{CAC}” that is generated by a delay element 231. (As mentioned above, t_{CAC} is calibrated to account for a roundtrip delay time associated with the read operation.) The 128 b read data block and the 16 b EDC sub-block can then be passed to the core (not shown) of memory controller 204 to detect/correct errors.

Note that memory system 200 can also be used for non-EDC accesses. In this case, 128 b data can be fetched from each of the two banks (no EDC), thereby achieving twice the data bandwidth. In this embodiment, the two accesses on the two bank groups do not have to be in lock-step, and the two addresses can be generated independently of each other. On the controller side, this may require that the 8-to-1 extracting circuit 232 be removed or bypassed, thereby causing modifications to the controller circuitry. However, this case does not require any change on the memory device.

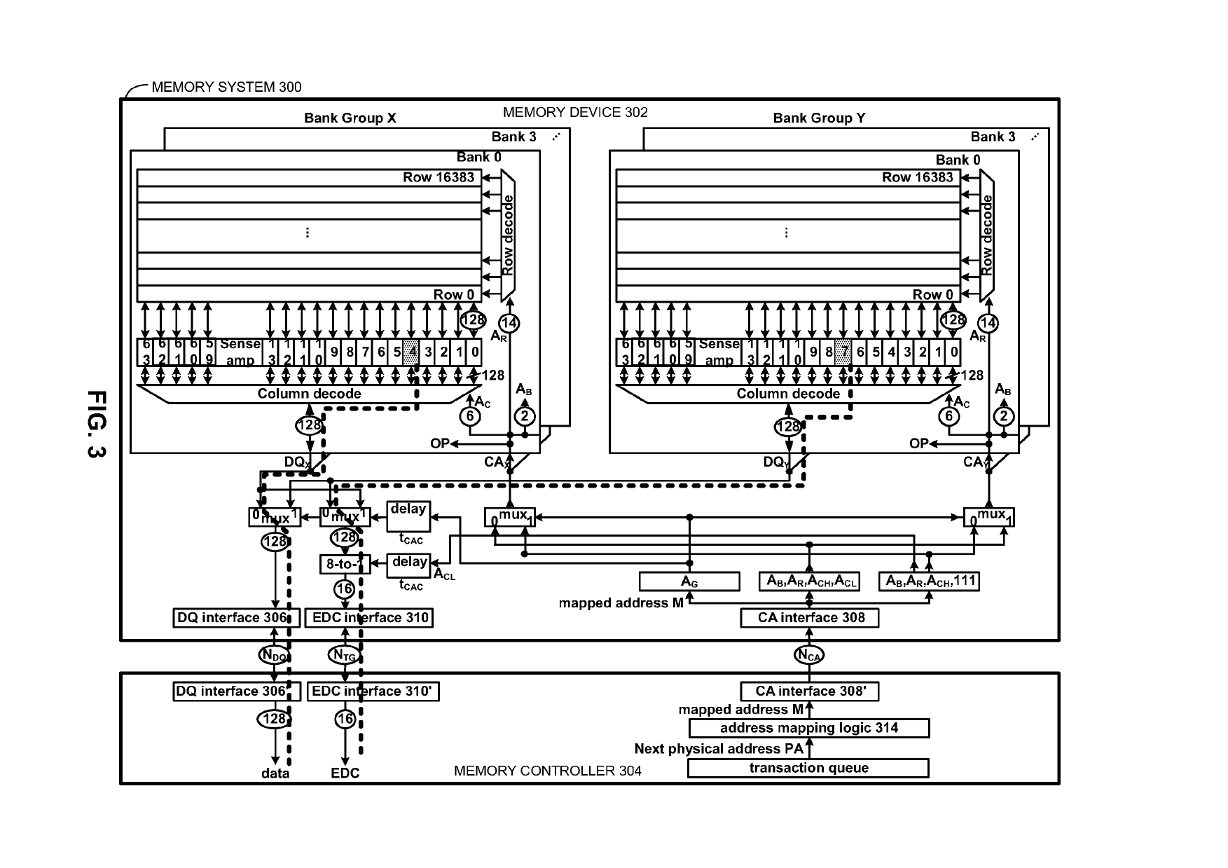

FIG. 3 illustrates an exemplary memory system 300 which uses EDC during read memory access. Compared with memory system 200, memory system 300 uses a modified memory device 302 and a modified memory controller 304. More specifically, modifications have been made to the interface blocks of memory device 302 relative to memory device 202 and also to the interface blocks of controller 304 relative to memory controller 204.

As illustrated in FIG. 3, similar to memory device 202, memory device 302 comprises two or more bank groups, including bank groups X and Y, and each bank group comprises four independent banks 0-3. Memory device 302 also differs from memory device 202 because memory device 302 uses a single set of DQ and CA interfaces, including interface block 306 and interface block 308, rather than using two or more identical sets as in memory device 202. The set of interface blocks 306 and 308 are shared by at least bank group X and bank group Y in memory device 302. Moreover, an EDC interface block 310 is included in memory device 302 which is also shared by the bank groups X and Y.

Memory device 302 is similar to memory device 202 in that each of the four banks in each of the two bank groups X and Y in memory device 302 contains 16K rows, wherein each row contains 64 blocks of column data, and each column block contains 128 b. Also, each bank group in memory device 302 couples to a separate set of 128 DQ (column data) signals and 32 CA signals. As illustrated in FIG. 3, the two sets of DQ and CA signals for the two bank groups are denoted as “DQ_{X},” “DQ_{Y},” “CA_{X},” and “CA_{Y},” to match the designations of the two bank groups X and Y in memory device 302.

In the embodiment of FIG. 3, the two sets of DQ and CA signals are then multiplexed into a single set of DQ and CA signals, which are subsequently coupled to the DQ and CA interface blocks 306 and 308 on the edge of memory device 302. The two sets of DQ signals are additionally multiplexed into a single set of EDC signals which are subsequently coupled to EDC interface block 310. Note that the 128 b EDC column block fetched from address “7” in bank group Y is passed through an 8-to-1 demultiplexer which selects the 16 b EDC sub-block corresponding to the fetched read data from address “4” in bank group X. As a result, the EDC interface block 310 has ⅛th the width of the DQ interface block 306, which facilitates reducing the power required for the EDC access. Note that the multiplexing operations which are performed on memory controller 204 in system 200 are similarly performed on memory device 302 in system 300. Hence, the multiplexers and the associated wires are moved from the controller side to the memory side of system 300. Moreover, multiplexers controlled by the associated bank-group-address-field A_{G} facilitate coupling DQ interface block 306 to one of the bank groups, and coupling EDC interface block 310 to the other bank group during a memory access.

Unlike in memory system 200, the physical address PA for the next memory access is converted into a single mapped address M (instead of two mapped addresses) by address mapping logic 314 on memory controller 304. The single mapped address is then passed across a CA interface 308′ on memory controller 304 and CA interface 308 on memory device 302, wherein the latter extracts the data and EDC bank addresses from the mapped address M. The bank-group-address-field (bit) A_{G} is also extracted and delayed in the same manner as in FIG. 2.

The functionality and timing of the two exemplary memory systems 200 and 300 are substantially the same but have a few differences. First, memory system 300 uses a smaller number of interface signals for passing EDC information. More specifically, system 300 requires 128 DQ, 16 EDC (due to the 8-to-1 demultiplexer), and 32 CA signals compared with 256 DQ and 64 CA signals for memory system 200. However, system 200 can provide twice the bandwidth of memory system 300 when each of the two systems operates in a non-EDC mode. Moreover, different types of memory devices may be used in memory system 200, for example, memory devices adhering to double data rate (DDR) standards, such as DDR2, DDR3, and DDR4, and future generations of memory devices, such as GDDR5, XDR, Mobile XDR, LPDDR, and LPDDR2.

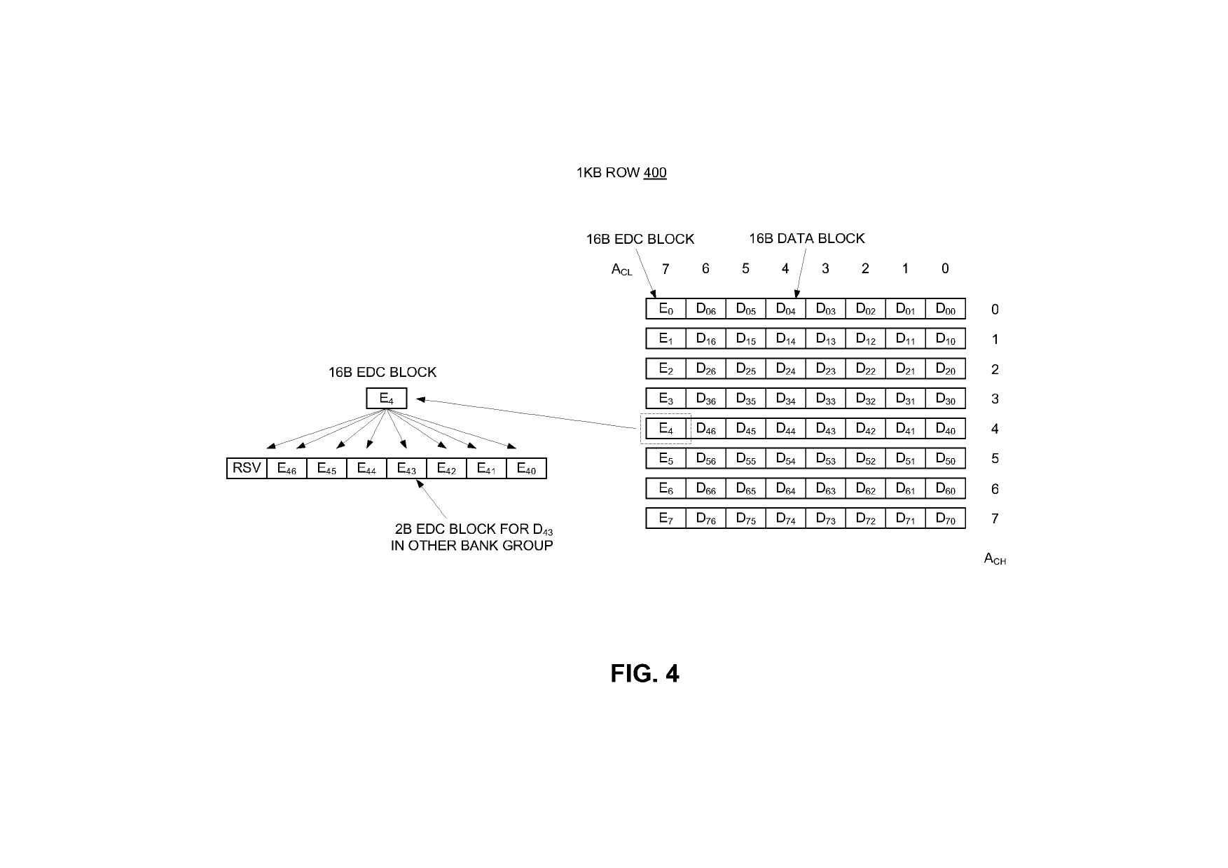

In the exemplary memory systems illustrated in FIGS. 2 and 3, the memory banks within each memory device have rows that are 1 KB in size, and each row contains 64 column blocks that are each 16 B in size. FIG. 4 illustrates an exemplary partition of a 1 KB row 400 in a memory bank into 64 blocks. For convenience of illustration, the 64 blocks in row 400 in FIG. 4 are arranged in an 8×8 array and indexed by the two mapped address fields: the lower order column-address field A_{CL} and the higher order column-address-field A_{CH}, which are both three bits in size. Note that this particular addressing configuration is not the only possible configuration. In general, other addressing alternatives can be used for the 64 column blocks.

In the 8×8 array of column blocks in row 400, 56 of the column blocks are used to store data (labeled as “D_{HL},” wherein “H” represents A_{CH} and “L” represents A_{CL}), and the other eight column blocks are used to store EDC information (labeled as “E_{H},” wherein “H” represents A_{CH}). In the exemplary row 400, for each group of eight adjacent column blocks, the lower seven column blocks are used for data and the highest one is used for EDC. Each EDC block is further subdivided into eight sub-blocks, each two bytes (2 B) in size. These sub-blocks within EDC block E_{H} are designated as “E_{HL},” wherein the value of the {H, L} column-address-fields identifies a data column block D_{HL} of the same column address in the other bank group which uses this EDC sub-block for its EDC information.

In the example illustrated in FIG. 4, sub-block E_{H7} in the EDC block is reserved because there is no corresponding D_{H7} data block in the other bank group. Because there are 8×7=56 column blocks in each row, it is necessary to perform a divide-by-7 operation when converting a physical address supplied by the memory controller into a mapped address which is used by the memory device. The address mapping logic used for this conversion is described in more detail below.

FIG. 5A illustrates exemplary address mapping logic 500 used in memory controller 304 (FIG. 3) to convert a physical address 502 (generated by the memory controller) to a mapped address which is used by the memory device. In this example, physical address 502 is a 27 b quantity which points to a 16 B column block in the physical memory. Hence, the physical memory space that is addressed by physical address 502 is a contiguous region of 2²⁷ blocks (2³¹ bytes). A divide-by-7 block 504 in address mapping logic 500 converts the 27 b physical address 502 into an intermediate address 506 which comprises a 25 b quotient and a 3 b remainder. The remainder is in the range {0, 1, . . . , 5, 6} and forms the address field A_{CL} in mapped address 508. This address field is used to select memory regions that are of non-power-of-two sizes (relative to the number of data column blocks).

An exemplary implementation of a single bit slice which can be combined with multiple identical bit slices to implement divide-by-7 block 504 is illustrated in FIG. 5B. In the bottom-right corner of FIG. 5B, the CP cell includes a carry-lookahead circuit (not shown in FIG. 5B).

The quotient is in the range of {0, 1, 2, . . . , 19173961} and is divided into different address fields to form a mapped address 508. These address fields include, but are not limited to, the row-address-field A_{R}, group-address-field A_{G}, bank-address-field A_{B}, and high column-address-field A_{CH}. These address fields all are used to select memory regions that are of power-of-two sizes, and these address signals may be freely swapped to provide the best possible performance for the application.

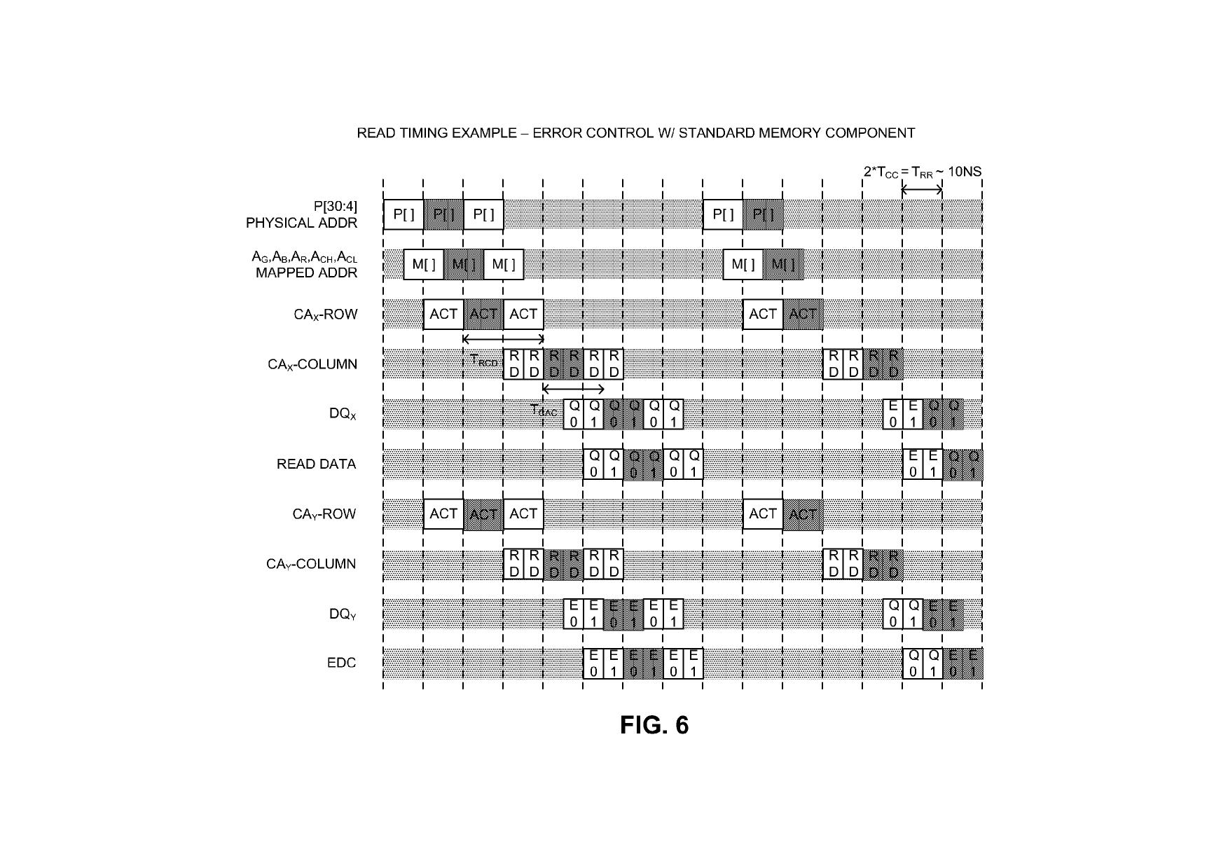

FIG. 6 illustrates the timing for various signals, including signals provided over various interface links during read accesses between the memory controller and memory components which appear in exemplary memory system 200. As illustrated in FIG. 6, a first set of three transactions labeled “P[ ]” are pipelined (overlapped) transactions containing physical addresses. After a slight delay, each transaction containing the physical address PA is converted to a mapped address M in the memory controller. Next, the address fields of the mapped address M are used to form memory access commands simultaneously directed to both bank group X and bank group Y. More specifically, for each transaction, two row-activate commands labeled “ACT” are simultaneously generated on the CA_{X}-row and CA_{Y}-row interface links, respectively. (The CA_{X}-row and CA_{Y}-row interface links correspond to the A_{R} 253 and A_{R} 255 signals, respectively, in FIG. 2.) Each row-activate command causes a row to be read out onto the sense-amp. After an additional delay, two column-read commands “RD” are conveyed over the CA_{X}-column interface links. At the same time, two column-read commands “RD” are transmitted through the CA_{Y}-column interface links (The CA_{X}-column and CA_{Y}-column interface links correspond to the A_{C} 252 and A_{C} 254 signals, respectively, in FIG. 2.) These row-activate and column-read commands result in substantially simultaneous read operations in bank groups X and Y, which subsequently cause read data “Q” to be returned on the DQ_{X} links, which is in lock-step with EDC information “E” returned on the DQ_{Y} links.

As mentioned previously, during the read memory access illustrated in FIG. 6, the address information associated with the commands directed to the X and Y bank groups are identical except that “111” is substituted for the A_{CL}, field when accessing the EDC information in bank group Y. The A_{CL} field is used to access a sub-block of the EDC block that is returned to the memory controller.

Also in FIG. 6, a second set of two transactions comprises a first memory transaction that accesses data in bank group Y and EDC information in bank group X, followed by a second memory transaction that accesses data in bank group X and EDC information in bank group Y. This example illustrates that accesses to the two bank groups can be interleaved in any order. Moreover, the example in FIG. 6 substantially minimizes the worst case latency to the data in a particular bank of a particular group by alternating the accesses in the manner shown.

FIG. 7 illustrates an exemplary memory system 700 which uses EDC information during write access. In an embodiment, memory system 700 includes a memory device 702 which is substantially identical to memory device 202 in FIG. 2, and comprises two or more bank groups. (As mentioned above, these bank groups comprise “independently accessible” memory segments.) More specifically, memory device 702 comprises a bank group X containing two or more independent banks which share dedicated DQ and CA interfaces. These interfaces facilitate performing a stream of interleaved (overlapped) accesses to the associated bank group. Moreover, the 1-to-8 insertion circuitry 710 in the lower left of FIG. 7 inserts a 16-bit subfield into a larger 128-bit field (with the other 112 bits of the larger field left at a default value of zero).

A write access is similar in some respects to a read access, except that the data is transported from memory controller 704 to memory device 702. There is also an additional set of control links N_{DM} to enable the selective writing of bytes within a 16 B column access. These control links allow 2 B EDC for the data write to be written to a corresponding 2 B EDC block as shown in FIG. 4 without overwriting other EDC or reserved data bits in the same 16 B EDC block addressed by A_{C}. The N_{DM} control links will typically only be used for non-EDC accesses. Moreover, the N_{DM} control links will probably not be available when performing an access with an EDC block—this is because the EDC value is typically computed across many bytes (for example, an 8-bit EDC block for a 64-bit data block). As a result, it is not possible to write a subset of the bytes in the data block because the EDC value will no longer apply to the mix of old and new bytes in the data storage location.

As illustrated in FIG. 7, the direction of the 2-1 multiplexers on memory controller 704 controlled by the group-address-field A_{G} has been reversed (compared to memory controller 204), so that the write data and EDC information can be directed to bank group X and bank group Y, respectively, or the write data and EDC information can be routed to bank group Y and bank group X, respectively.

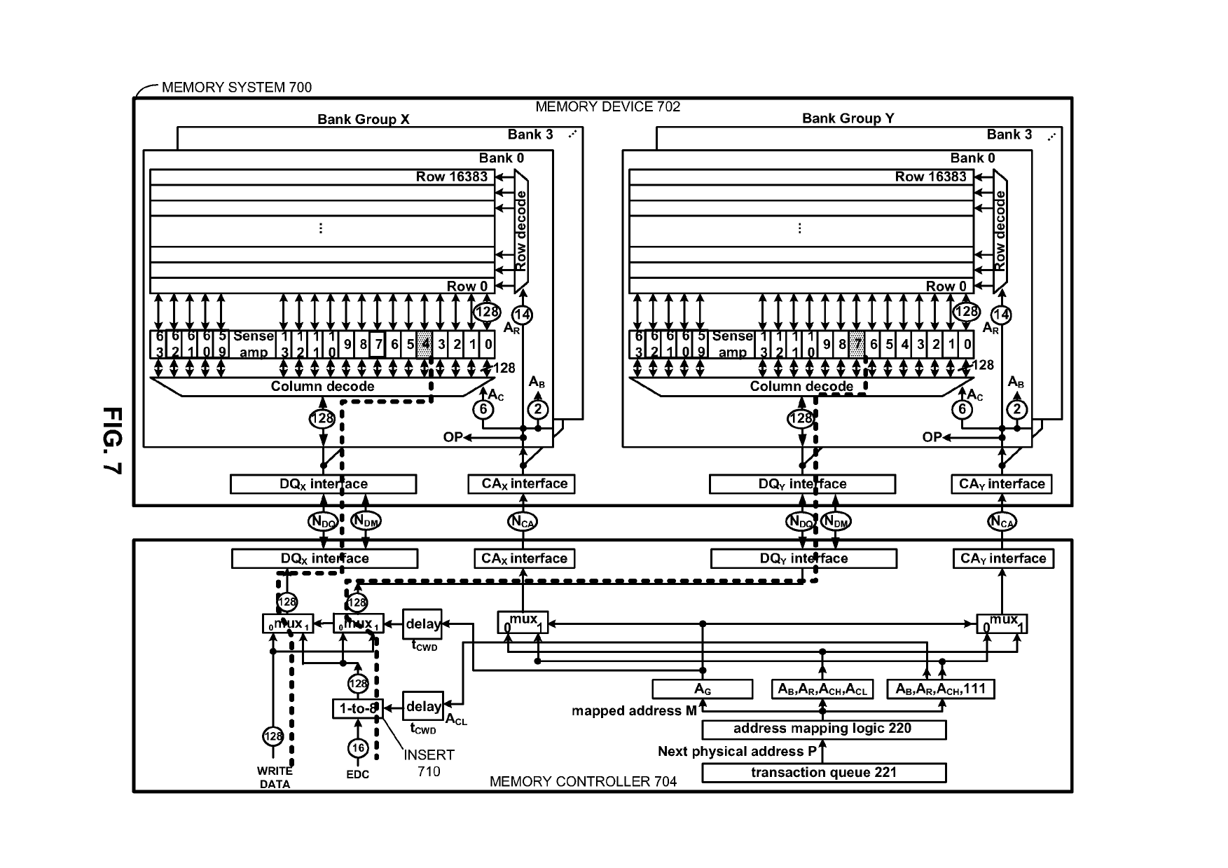

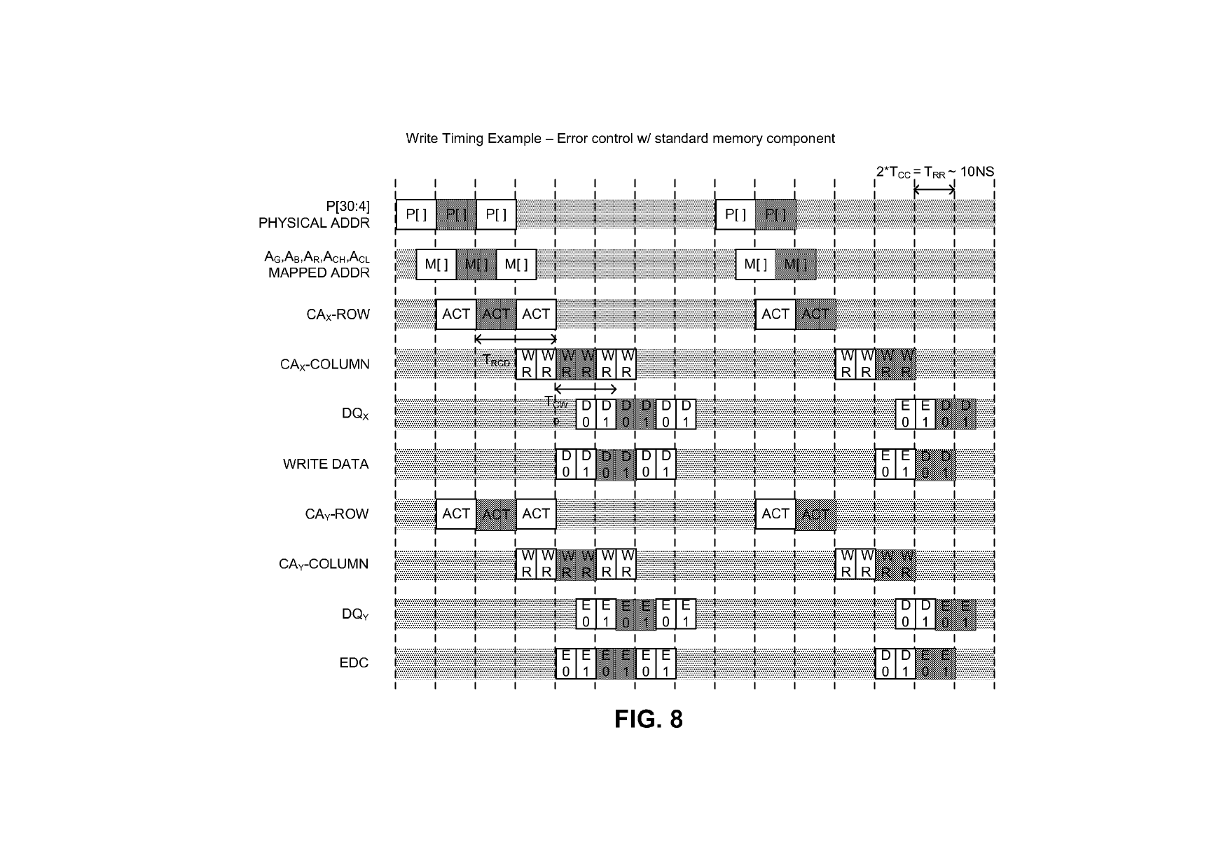

FIG. 8 illustrates the timing for various signals, including signals provided over various interface links during write accesses between the memory controller and memory components which appear in exemplary memory system 700. As illustrated in FIG. 8, a first set of three transactions labeled “P[ ]” are pipelined (overlapped) transactions containing physical addresses PA. After a slight delay, each transaction containing the physical address PA is converted into a mapped address M in the memory controller. Next, the address fields of the mapped address M are used to form memory access commands simultaneously directed to both bank group X and bank group Y. More specifically, for each transaction, two row-activate commands labeled “ACT” are simultaneously generated on the CA_{X}-row and CA_{Y}-row interface links, respectively. After an additional delay, two column-write commands “WR” are generated on the CA_{X}-column interface links, and at the same time two column-write commands “WR” are generated on the CA_{Y}-column interface links. These row-activate and column-write commands cause simultaneous write operations in the bank groups X and Y, which subsequently cause write data to be transferred on the DQ_{X} links, which is in lock-step with EDC information “E” transferred on the DQ_{Y} links.

As mentioned previously, during the read access illustrated in FIG. 8, the address information associated with the commands to the X and Y bank groups is identical except that “111” is substituted for the A_{CL} field when accessing the EDC information in bank group Y. The A_{CL} field is used to access an associated EDC sub-block that is written to the memory device.

Also in FIG. 8, a second set of two transactions includes a first memory transaction that writes data into bank group Y and writes EDC information into bank group X, followed by a second memory transaction that writes data into bank group X and EDC information into bank group Y. This example illustrates that accesses to the two bank groups can be interleaved in any order. Moreover, the example in FIG. 8 substantially minimizes the worst case latency to the data in a particular bank of a particular group by alternating the accesses in the manner shown.

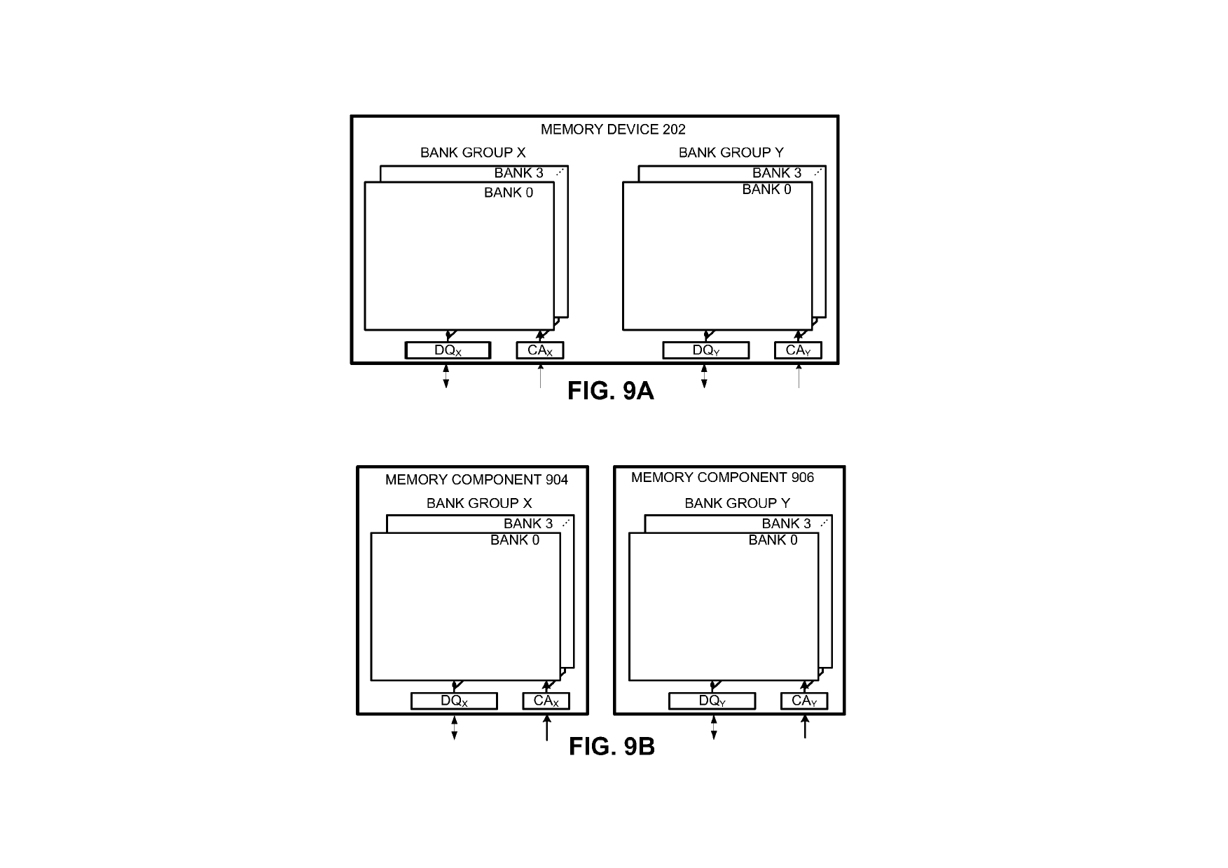

FIGS. 9A and 9B illustrates various bank group configurations for bank groups X and Y in memory device 202 (FIG. 9A) and two memory components 904 and 906 (FIG. 9B). In the embodiment of FIG. 9A, memory device 202 is a single memory component containing the two bank groups (X and Y) and two sets of DQ and CA interfaces. FIG. 9B illustrates two memory components 904 and 906, wherein each of the two memory components includes a single bank group (X or Y) and one set of corresponding DQ and CA interfaces. Both “memory component” and “memory device” are a memory IC.

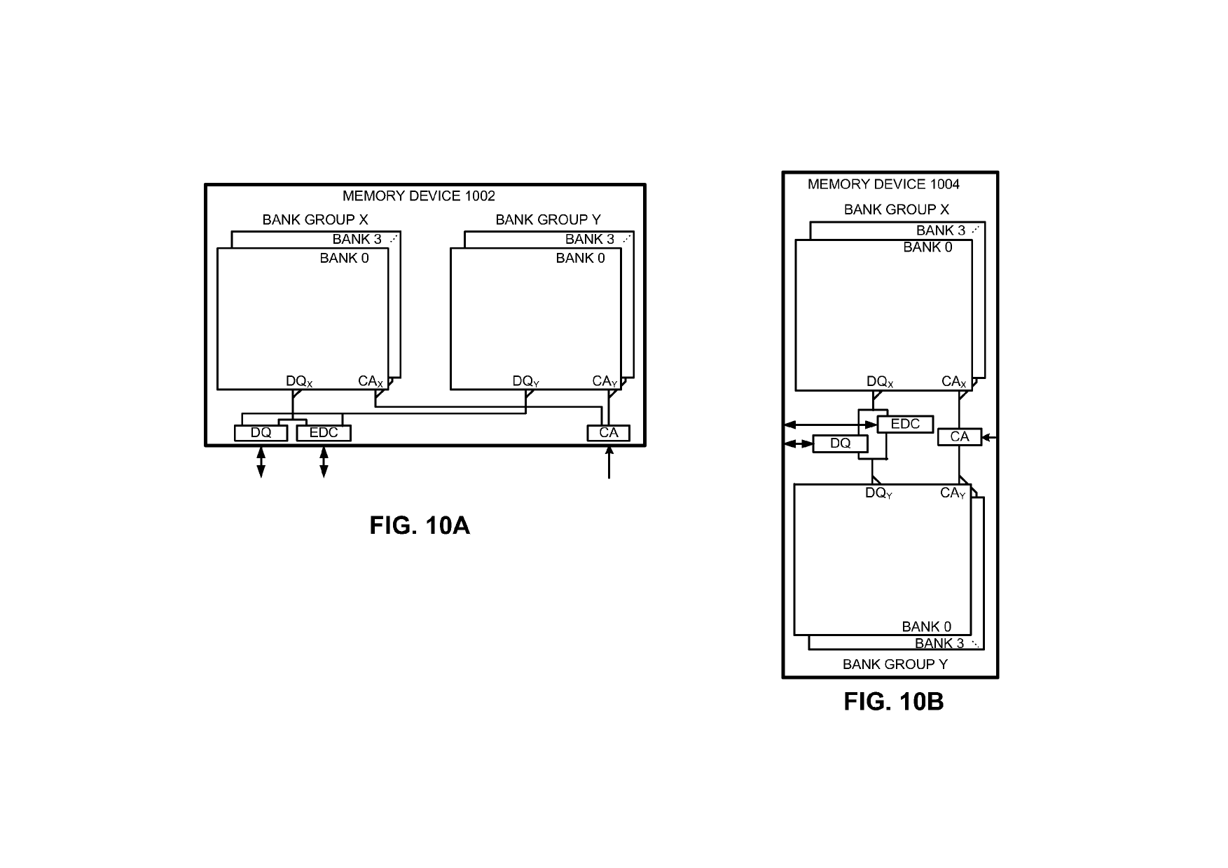

FIGS. 10A and 10B illustrate two variations of memory device 302 illustrated in FIG. 3. More specifically, FIG. 10A illustrates a memory device 1002 which includes two bank groups X and Y are located side-by-side. As is described above in conjunction with FIG. 3, bank groups X and Y in memory device 1002 share one set of DQ, EDC, and CA interfaces. Note that the configuration of the two bank groups in memory device 1002 requires the internal DQ and CA signals to be routed along an edge of memory device 1002. Typically, this configuration requires a larger chip size but allows the interface components to reside at different locations. These interface components can include the multiplexing/routing logic and wiring that facilitates connecting either bank group to the DQ interface while the other bank group connects to the EDC interface. Recall that the single CA interface can also be modified to produce the two sets of addresses needed to access the data and EDC information in the two bank groups.

In contrast, FIG. 10B illustrates a memory device 1004 which includes two bank groups X and Y placed in an alternative configuration. Similar to memory device 1002, independent bank groups X and Y in memory device 1004 also share one set of DQ, EDC, and CA interfaces. However, the alternative configuration of the two bank groups in memory device 1004 requires the internal DQ and CA signals to be routed through the center of memory device 1004. This configuration allows a smaller chip size, but requires interface components to be placed between the two bank groups (as shown in FIG. 10B). In some embodiments, the interface components are approximately placed at the midpoint between the two bank groups. These interface components can include the multiplexing/routing logic and wiring which enables either bank group to connect to the DQ interface while the other bank group connects to the EDC interface. Note that the more symmetric placement of the interface components within memory device 1004 allows the wiring to be significantly shorter than the interface wiring in memory device 1002. Moreover, the reduced chip size and wiring of memory device 1004 can reduce manufacturing costs. As in memory device 1002, the single CA interface in memory device 1004 can also be modified to produce the two sets of addresses to access the data and EDC information in the two bank groups.

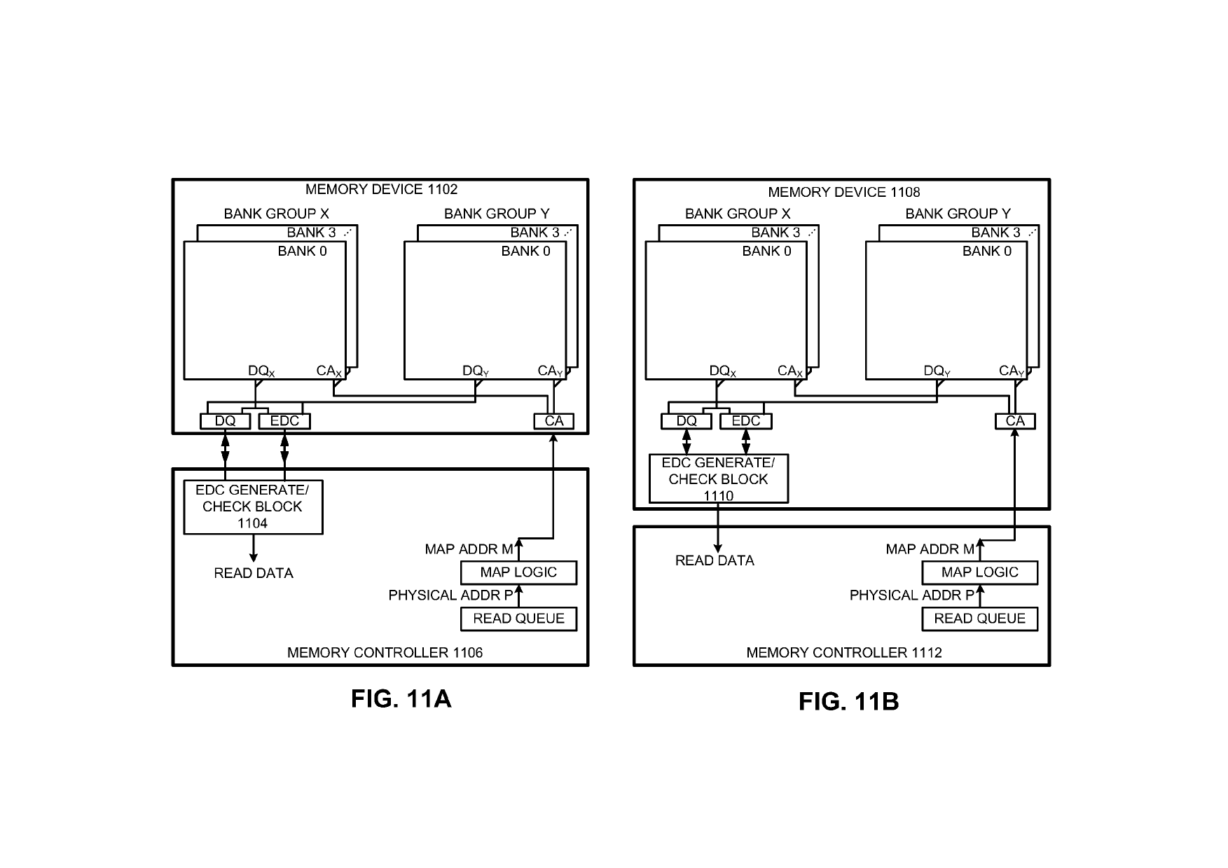

FIGS. 11A and 11B illustrate embodiments in which EDC generate/check logic is disposed on memory device 1102 (FIG. 11B) or memory controller 1106 (FIG. 11A). More specifically, FIG. 11A illustrates a memory device 1102 wherein an EDC generate/check block 1104 (including both an EDC check logic block for read and an EDC generate logic block for write) is located in a corresponding memory controller 1106 instead of on memory device 1102. In contrast, FIG. 11B illustrates a memory device 1108 wherein an EDC generate/check block 1110 (including both an EDC check logic block for read and an EDC generate logic block for write) is located in memory device 1108, instead of in a corresponding memory controller 1112. While both of these embodiments illustrate using two independent bank groups on a single memory component, the embodiment of FIG. 11A (i.e., putting error correction on the controller) can also be implemented using a separate memory component to contain each bank group.

In the embodiment of FIG. 11A, both the EDC check logic block for read and the EDC generate logic block for write are included in the memory controller 1106. While the technique illustrated in FIG. 11A may require additional chip area on both memory device 1102 and memory controller 1106 to accommodate the EDC interfaces, this technique does not burden the memory device with the cost of implementing the EDC generate/check logic. Consequently, this technique is more flexible because the memory controller can implement non-conventional EDC generate/check logic, or it can use the EDC storage and interface for non-EDC purposes.

In the embodiment of FIG. 11B, both the EDC check logic block for read and the EDC generate logic block for write are included in the memory device 1108. While the technique illustrated in FIG. 11B saves the chip area on both memory device 1108 and memory controller 1112 for the EDC interfaces, this technique requires the memory device to implement the EDC check/generate logic. Typically, the transistor performance is lower and the number of wiring layers is more limited for a memory process than for a logic process. Consequently, this technique limits the type of EDC generate/check logic that can be used.

The above-described embodiments are applicable to different types of memory devices, for example, memory devices adhering to double data rate (DDR) standards, such as DDR2, DDR3, and DDR4, and future generations of memory devices, such as GDDR5, XDR, Mobile XDR, LPDDR, and LPDDR2. However, these embodiments may differ in a number of respects, such as in the structure of the interface logic, the number of bank groups, and the number of memory banks within each bank group in a given memory device.

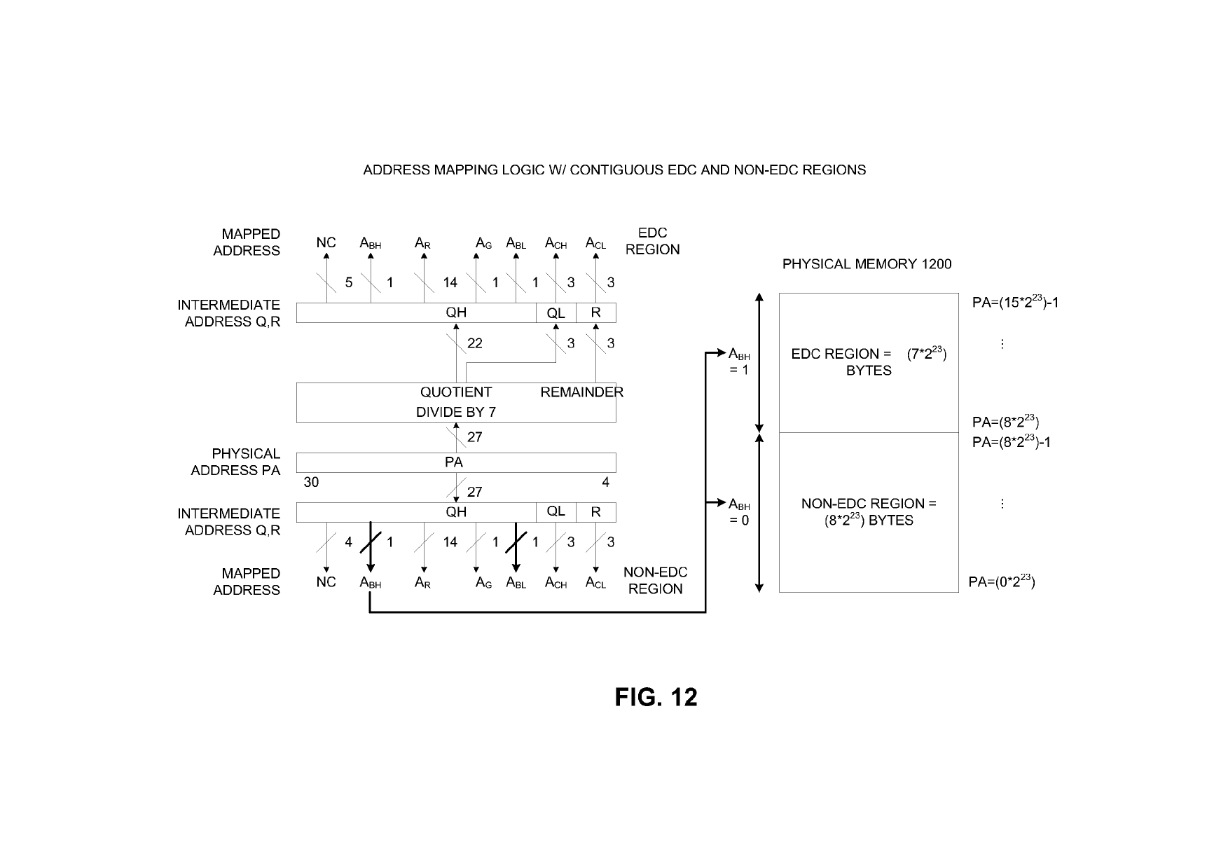

FIG. 12 illustrates address mapping logic that can be used to create two contiguous regions within a physical memory 1200: one with EDC detection/correction and the other one without EDC detection/correction. This can be implemented by using a high-order physical bit A_{BH} to select two sets of regions, and by applying two mapping functions to the two sets. (Other embodiments can use more than one bit to produce other splits, which for example may dedicate ¼ or ⅛ of physical memory to an EDC region.) The upper region in physical memory 1200 with EDC detection/correction stores ⅞ as many data bits as the lower region in physical memory 1200, which does not provide EDC detection/correction. Moreover, there is no address-space gap between the two regions.

FIG. 12 uses a single bank-address bit to discriminate between the non-EDC and EDC regions of physical address space. A finer degree of discrimination is possible by additionally using row address bits. This requires a comparison of the physical-row address AR to an address threshold value (held in a control register). Row addresses less than the threshold are non-EDC accesses, and row addresses equal to or greater than the threshold are EDC accesses. This threshold comparison may include a combination of row and bank address bits, or may include only row address bits, or only bank address bits. The address field used for comparison must include the highest order address bits with no gaps. In FIG. 12, with a physical address PA[30:4] (wherein PA[30:27] is unused), the high-order comparison address bit would correspond to PA[26], and the comparison field would include PA[26] and some number of contiguous address bits (PA[25], PA[24}, . . . ).

Accessing Data and EDC Information from a Single Memory Bank

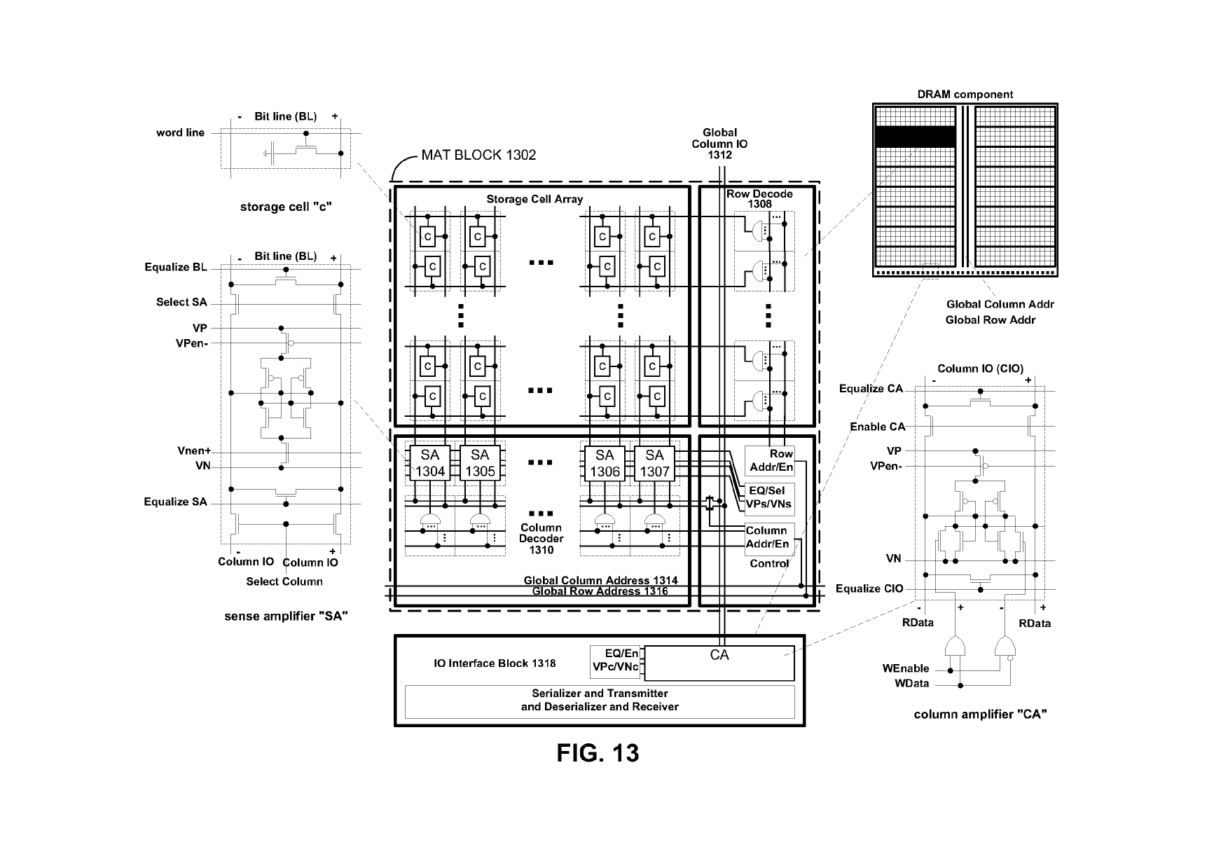

FIG. 13 illustrates elements of an exemplary memory core for a dynamic random access memory (DRAM) component according to various embodiments described herein. (Note that the acronym “CA” in FIG. 13 refers to a “column amplifier,” instead of “command/address links” as was used previously in this specification.) As illustrated in FIG. 13, each block labeled “c” is a storage cell for a single bit. This storage cell includes a storage capacitor and an access transistor. An array of these storage cells is referred to as a “mat block,” such as mat block 1302. The mat also includes a row of sense amplifiers “SA” 1304-1307 which are configured to sense a row of storage cells. The row decode structure 1308 on the right side of the mat block 1302 selects the row to be accessed based on a row address.

When the contents of a row of memory cells has been sensed by the sense amplifiers 1304-1307, the row can be read from and written to using column access operations. A group or single one of the sense amplifiers 1304-1307 can be selected via the column decoder structure 1310 along the bottom of mat block 1302. The single sense amplifier's signal can be accessed through the global column IO signal 1312 which runs vertically through the mat. Global column address 1314 and global row address 1316 signals run horizontally through the mat.

In an embodiment, mat block 1302 is replicated vertically and horizontally to form an independent bank. The horizontal width of the bank determines the number of column I/O signals which are passed to the interface block. Also, the interface block 1318 typically serializes the data so that it can be transmitted and received at a higher signaling rate than what is used on the global column I/O signals.

One dimension (e.g., the vertical height) of the bank may be used to determine the number of rows that are included in a bank. Each bank can provide access to a row in each row-to-column access time (t_{RC}) interval (for example, 50 ns). In addition, each bank can provide access to a block of column information in each column-to-column access time (t_{CC}) interval (for example, 5 ns). Note that in an embodiment a bank group comprises two or more independent banks, and row operations can start on any of the banks that are not currently busy at each row-to-row time interval (t_{RR}) (for example, 10 ns).

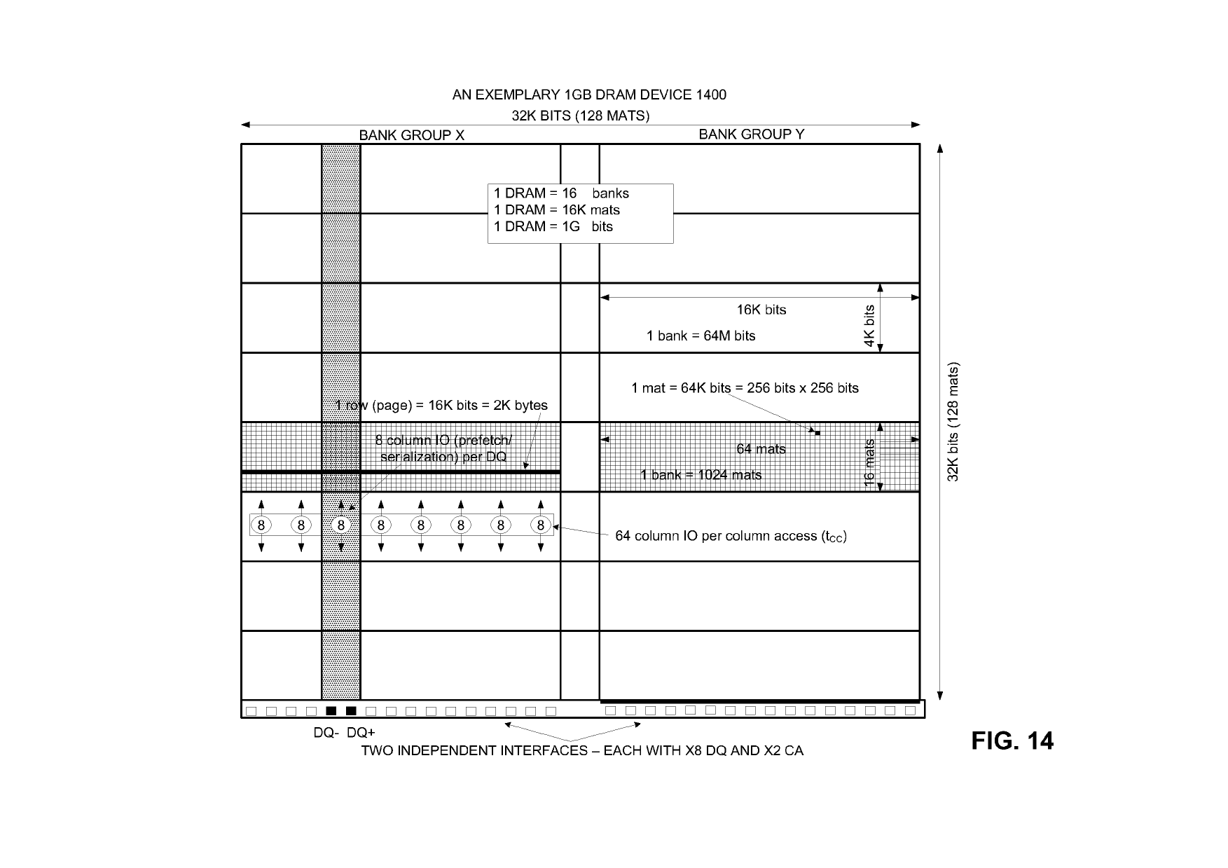

FIG. 14 illustrates an exemplary 1 Gbit DRAM memory device 1400 constructed from the mat elements described in FIG. 13. As shown in FIG. 14, memory device 1400 contains two independent bank groups X and Y in the left half and right half of memory device 1400, respectively. In this embodiment, each bank group is coupled to a dedicated CA interface (not shown) to receive control, command, and address information. Additionally, each bank group in this embodiment has a dedicated data (DQ) interface. In this embodiment, the DQ connection sites are disposed near a die edge (e.g., along the bottom) of memory device 1400.

In this example, each bank group contains eight independent banks, and bank operations can be interleaved, with a row access starting in each t_{RR} interval, and a column access starting in each t_{CC} interval.

Each bank further includes 1024 mat blocks, organized as a 16×64 array of mat blocks. Each mat block is coupled to one global column I/O, so that each bank group accesses 64 bits in each column cycle interval (t_{CC}). Each mat block also contains 256×256 bits in this example.

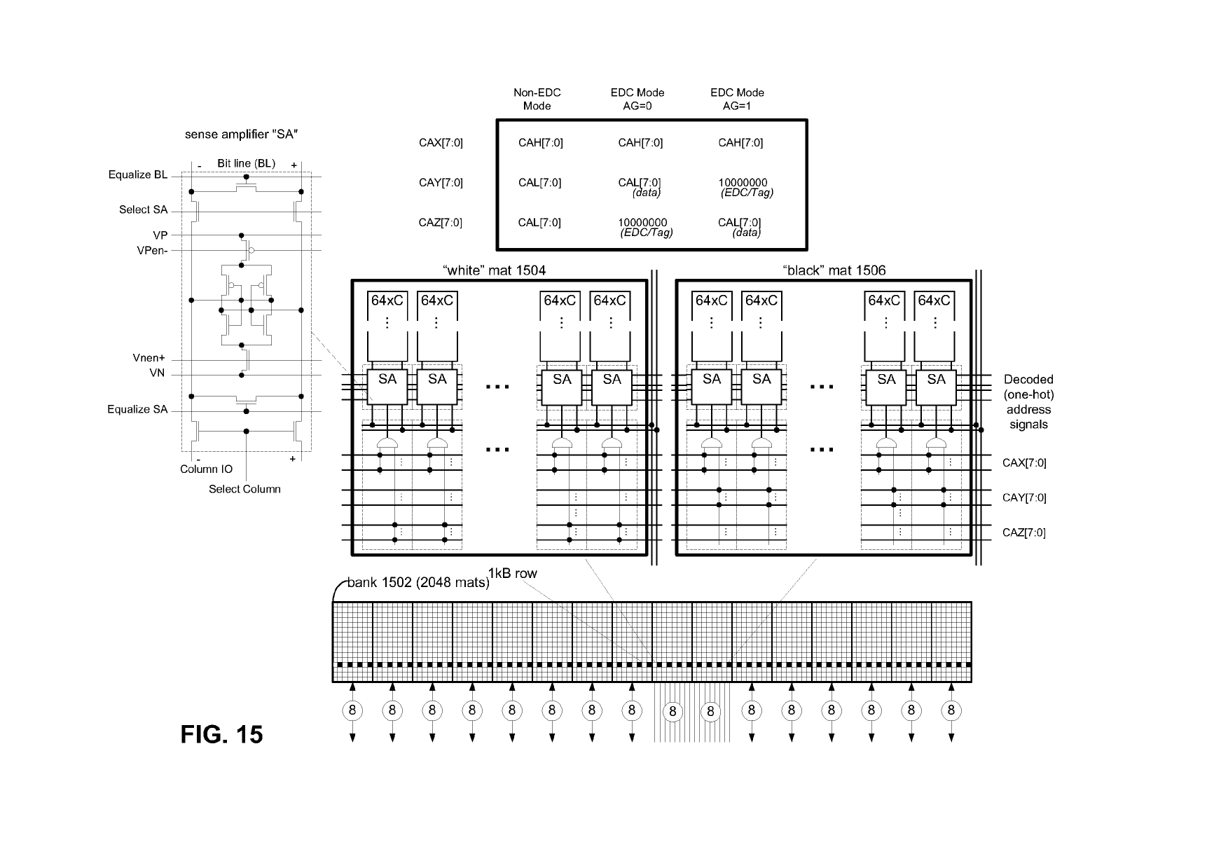

FIG. 15 illustrates an embodiment of a memory device in which the column access path is structured such that, in a memory bank (or bank group), the data and EDC information is stored in the same row. This column access path architecture eliminates the need to use two independent bank groups to access data and EDC information.

As shown in FIG. 15, memory bank 1502 comprises 2048 mat blocks organized as a 16×128 mat array (similar to the structure discussed in conjunction with FIGS. 13 and 14). A row in the mat array contains alternating “black” and “white” mats. (These black and white mats comprise “independently accessible” memory array segments. Also note that although FIG. 15 only shows black/white tiling for one stripe of mats in the bank, every strip in the embodiment is tiled in a similar way.) In one embodiment, each mat is 64×64 in size. In some embodiments, for each pair of adjacent black and white mats, one mat is used for data and the other is used for the corresponding EDC signals. This embodiment combines data and the EDC words, each 64 b long, at the same location in a memory bank. Compared with mat block 1302 in FIG. 13, mats in bank 1502 provide additional column address signals, i.e., CAX, CAY, and CAZ, each 8 b long. The black and white mats are then coupled to the different sets of column address signals. For example, the white mats (such as mat 1504) couple to the CAX and CAZ column address signals, and the black mats (such as mat 1506) couple to the CAX and CAY column address signals.

As shown in the table in FIG. 15, during a non-EDC memory access, both CAY and CAZ signals couple to the decoded CAL address field, and a combined 128 b column block is accessed (one bit from each of the 16×8 mats containing the selected row). Meanwhile, the CAX signals are coupled to the decoded CAH address field.

In contrast, during an EDC memory access, the decoded CAL address field is driven onto either of the CAY/CAZ signals to select the 64 b of data, while “10000000” is driven onto the CAZ/CAY signals to select the 64 b of EDC information. Next, the 8 b of EDC for the 64 b data block is selected by additional logic (not shown) using the CAL address field. The selection of CAY/CAZ for data/EDC or EDC/data is made based on the group-address-field A_{G} (note that, unlike the previous embodiments, A_{G} is not used to select a bank group here, but is instead serving as essentially another column address bit).

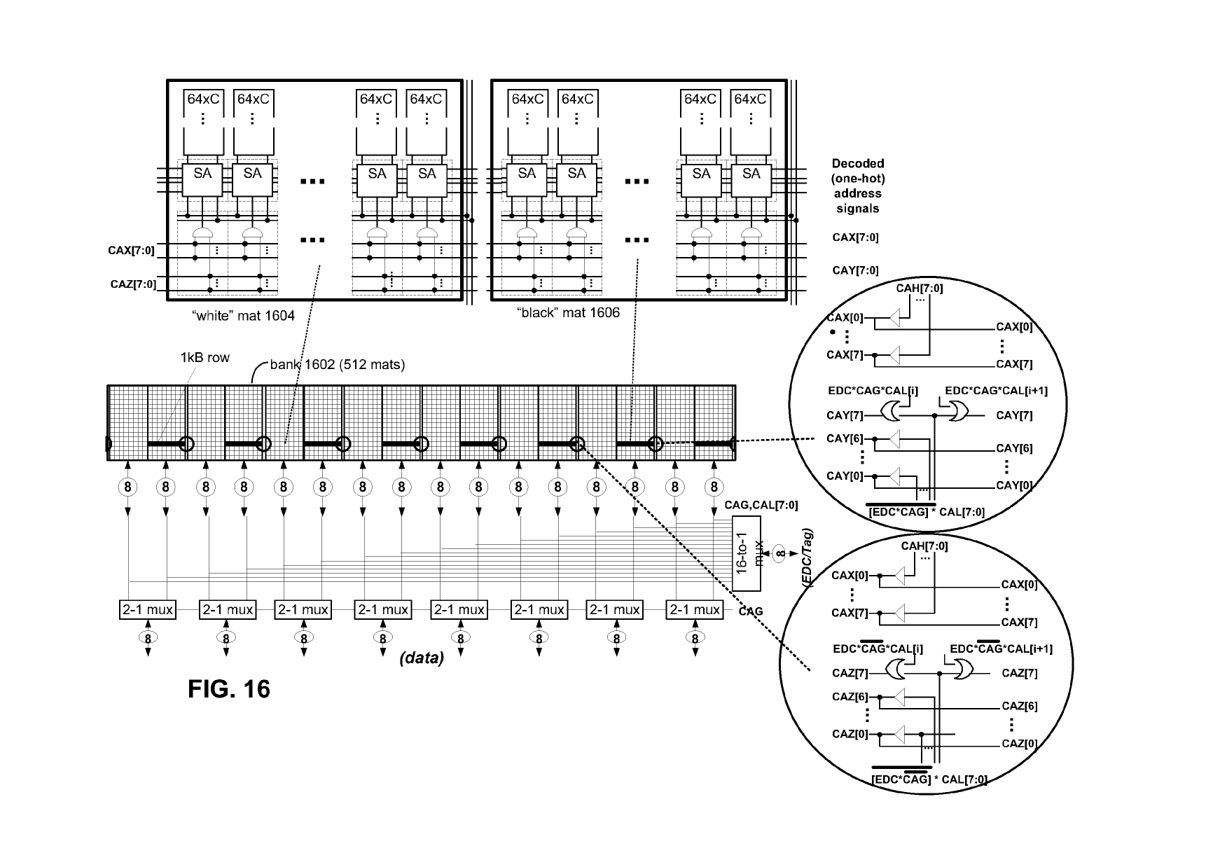

FIG. 16 illustrates an embodiment of a memory device in which the column access path is structured such that, in a memory bank (or bank group) the data and EDC information is stored in the same row. In comparison with the embodiment of FIG. 15, this embodiment can achieve additional power savings.

As shown in FIG. 16, memory bank 1602 comprises 512 mat blocks. Moreover, each mat array includes alternating groups of eight mat blocks (“white” and “black”), which couple to different sets of column address logic. (Note that although FIG. 16 only shows black/white tiling for one stripe of mats in the bank, every strip in the embodiment is tiled in a similar way. Moreover, as mentioned above, these black and white mats comprise “independently accessible” memory array segments.) For example, white mats (such as mat 1604) couple to the CAX and CAZ column address signals, whereas black mats (such as mat 1606) couple to the CAX and CAY column address signals. There is a single set of CAX and CAZ column address signals driven from this logic. During a non-EDC access, the CAX and CAY signals couple to the decoded CAH and CAL address fields, and a single 128 b column block is accessed (one bit from each of the 16×8 mats containing the selected row).

In contrast, during an EDC access, the decoded CAH address field is driven onto either of the CAX signals as before. However, the CAY signals are gated by the CAG address field, so that CAY is driven by CAL for the 64 data mat blocks. Moreover, the CAG and CAL[7:0] signals gate CAY for the EDC mat blocks, so that CAY is driven with “00000000” for seven of the EDC 8-mat block groups and by “10000000” for one of the EDC 8-mat block groups. As a result, column access power will not be consumed by the EDC information that is not needed.

The preceding description was presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein. Accordingly, many modifications and variations will be apparent to practitioners skilled in the art.

Additionally, the above disclosure is not intended to limit the present description. The scope of the present description is defined by the appended claims.

Also, some of the above-described methods and processes can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and apparatus described can be included in but are not limited to, application-specific integrated circuit (ASIC) chips, field-programmable gate arrays (FPGAs), and other programmable-logic devices.

1. A memory controller, comprising:
a circuit to generate
a first address identifying a first memory array to store first data, and
a second address identifying a second memory array to store second data; and
an interface to provide
for storage in the first memory array, the first data and error information associated with second data, and
for storage in the second memory array, the second data and error information associated with first data.

2. The memory controller of claim 1, wherein the memory controller is configured to access a first data word from the first memory array in parallel with accessing error information for the first data word from the second memory array.

3. The memory controller of claim 1, wherein the memory controller further comprises circuitry for generating and checking the error information.

4. The memory controller of claim 1, wherein:
the memory controller is configured to store unprotected data words without error information;
data words with error information are stored in a first region of memory; and
the unprotected data words without error information are stored in a second region of memory.

5-13. (canceled)

14. The memory controller of claim 1, wherein:
the memory controller further comprises an address-translation circuit that translates a physical address for a memory reference into a mapped address; and
the translation process intersperses consecutive data words with consecutive EDC syndromes, so that data words in the first data are associated with corresponding EDC syndromes in the second data, and data words in the second data are associated with corresponding EDC syndromes in the first data.

15. (canceled)

16. A method of operation of a memory controller, the method comprising:
generating a first address that identifies a first memory array to store first data;
generating a second address that identifies a second memory array to store second data;
outputting the first data and error information associated with second data, for storage in the first memory array; and
outputting the second data and error information associated with first data, for storage in the second memory array.

17. The method of claim 16, wherein the method further comprises using the first address to access a first data word from the first memory array in parallel with using the second address to access error information for the first data word from the second memory array.

18-20. (canceled)

21. The method of claim 16, wherein:
the first memory array and the second memory array comprise different bank groups;
the first memory array is located in a first memory device; and
the second memory array is located in a second memory device.

22. The method of claim 16, wherein the first memory array and the second memory array comprise different bank groups which are located in the same memory device.

23. The method of claim 16, wherein the first memory array and the second memory array are associated with different columns in a memory device, so that a given row in the memory device includes bits associated with the first memory array and bits associated with the second memory array.

24. (canceled)

25. A method of operation of a memory controller, the method comprising:
generating a command to access data from a memory device coupled to the memory controller, the memory device having first and second storage arrays;
transmitting to the memory device, a first address that identifies a storage location within the first storage array for the data; and
transmitting to the memory device, a second address that identifies a second storage location within the second storage array for error information associated with the data.

26. The method of claim 25, wherein:
error information for a first data word located in the first memory array is stored in the second memory array; and
error information for a second data word located in the second memory array is stored in the first memory array.

27. The method of claim 25, wherein:
a given data word includes 64 bits of data; and
the error information for the given data word includes an 8-bit EDC syndrome for the given data word.

28. The method of claim 27, wherein groups of consecutive EDC syndromes are interspersed between groups of consecutive data words.

29. The method of claim 25, wherein a given data word is accessed in parallel with the error information for the given data word.

30-33. (canceled)

34. A memory device, comprising:
at least a first and a second storage array;
a command interface to receive a command to write data to a first storage location within the first storage array;
a first interface to receive data associated with the command; and
a second interface to receive error information associated with the data, wherein the error information is stored in the second storage array.

35. The memory device of claim 34, wherein:
the set of storage locations is organized into multiple independently accessible memory arrays, including a first memory array and a second memory array; and
the memory device is to store data words along with associated error information for the data words so that
error information for a first data word located in the first memory array is stored in the second memory array, and
error information for a second data word located in the second memory array is stored in the first memory array.

36. The memory device of claim 34, wherein the memory device further comprises circuitry for generating and checking the error information.

37. The memory device of claim 34, wherein the memory device is to:
simultaneously receive a first read access request directed to the first data word in the first memory array and a second read access request directed to the error information for the first data word in the second memory array; and
in response to the first and second read access requests, read out the first data word from the first memory array in parallel with reading out the error information for the first data word from the second memory array.

38. The memory device of claim 34, wherein the memory device is to:
simultaneously receive a first write access request directed to the location of the first data word in the first memory array and a second write access request directed to the location of the error information for the first data word in the second memory array; and
in response to the first and second write access requests, write a new data word to the location of the first data word in the first memory array in parallel with writing new error information for the new data word to the location of the error information for the first data word in the second memory array.

39-49. (canceled)

50. The memory device of claim 34, wherein
the memory device includes
a first set of memory banks, and
a second set of memory banks;
the first and second sets of memory banks are oriented on the memory device so that data (DQ) lines and command/address (CA) lines are coupled to the first and second sets of memory banks through signal lines which run along one side of the memory device.

51. The memory device of claim 34, wherein:
the memory device includes
a first set of memory banks, and
a second set of memory banks;
the first and second sets of memory banks are oriented on the memory device so that data (DQ) lines and command/address (CA) lines are coupled to the first and second sets of memory banks through signal lines located between the first and second sets of memory banks.

52-61. (canceled)
